(19) United States
(12) Patent Application Publication
(10) Pub. No.: US 2011/0113218 A1
(43) Pub. Date: May 12, 2011

(54) CROSS FLOW PARALLEL PROCESSING METHOD AND SYSTEM

(75) Inventors: Jung Hee LEE, Daejeon (KR); Bhum Cheol LEE, Daejeon (KR); Tae Sik CHEUNG, Daejeon (KR)

(73) Assignee: Electronics and Telecommunications Research Institute, Daejeon (KR)

(21) Appl. No.: 12/906,576

(22) Filed: Oct. 18, 2010

(30) Foreign Application Priority Data
Nov. 9, 2009 (KR) 10-2009-0107385
Mar. 5, 2010 (KR) 10-2010-0019896

(51) Int. Cl. G06F 15/76; G06F 9/00

(52) U.S. Cl. 712/18; 712/E09.001

(57) ABSTRACT

Provided is a cross flow parallel processing method and system that may process multiple data flows and increase a parallel processing rate in a multi-processor that processes multiple cross data flows.

### CROSS-REFERENCE TO RELATED APPLICATION(S)

This application claims the benefit of Korean Patent Application Nos. 10-2009-0107385 and 10-2010-0019896, respectively filed on Nov. 9, 2009 and Mar. 5, 2010, in the Korean Intellectual Property Office, the disclosures of which are incorporated herein by references.

### BACKGROUND

1. Field of the Invention

The present invention relates to a cross data flow processing method and system that may process multiple cross data flows by maximizing parallel processing in a multi-processor.

2. Description of the Related Art

A multi-processor may have an advantage of containing various programs that are advantageous in a data processing performance and power consumption and thus, utilization thereof in a terminal, home electric appliances, communication, broadcasting, and the like may increase.

Multi-processors have been used for network processors to improve a packet processing rate in networks including a layer 2 through a layer 4 since the year 2000. A conventional method suggests a method of increasing a parallel processing rate to maximize the advantages of the multi-processor.

The conventional method may decrease a serial processing rate of individual processors in the multi-processor and may increase the parallel processing rate and thus, a processing rate of the multi-processor may linearly increase in proportion to a number of processors. Also, a head of line block (HOL) may be decreased and thus, a packet processing time may decrease.

However, the conventional method may perform a processing based on a packet-by-packet scheme or based on a flow-by-flow scheme. Therefore, there may be difficulty in using a result of the processing in real time after packets are processed.

### SUMMARY

An aspect of the present invention provides a cross flow parallel processing method and system that may generate a data flow to increase a parallel processing rate in a multi-processor and may assign a sequence number to the data flow and thus, the parallel processing rate is maximized and the parallel processing may be performed based on multiple cross flow units in addition to parallel processing performed based on a flow unit.

According to an aspect of the present invention, there is provided a cross flow parallel processing system, the system including a parser and time-dependent flow identification driver to generate a hash value with respect to inputted data and to generate a data flow including the generated hash value, a scheduler to assign, based on the generated hash value, the generated data flow to an available processor, and a multi-processor array to include multiple processors, and each processor of the multiple processors processes data flow assigned by the scheduler.

According to an aspect of the present invention, there is provided a cross flow parallel processing system, the system including a parser and time-dependent flow identification driver to generate a hash value with respect to an inputted IP packet, and to generate an IP flow having the generated hash value, a scheduler to assign, based on the hash value, the generated IP flow to an available processor, and a multi-processor array to include multiple processors, and each processor of the multiple processors processes the assigned IP flow.

According to an aspect of the present invention, there is provided a cross flow parallel processing method, the method including generating a hash value with respect to an inputted data, generating a data flow having the generated hash value, assigning, based on the generated hash value, the generated data flow to an available processor, and processing the data flow in a processor to which the data flow is assigned among multiple processors.

According to an aspect of the present invention, there is provided a cross flow parallel processing method, the method including generating a hash value with respect to an inputted IP packet, generating an IP flow having the generated hash value, assigning, based on the generated hash value, the generated IP flow to an available processor, and processing the generated IP flow in a processor to which the generated IP flow is assigned among multiple processors.

Additional aspects, features, and/or advantages of the invention will be set forth in part in the description which follows and, in part, will be apparent from the description, or may be learned by practice of the invention.

According to embodiments, an operation with respect to multiple cross flows may be performed and thus, a parallel processing rate may increase in a multi-processor.

According to embodiments, layers having different attributes are classified and may be parallel-processed and thus, a locality may be overcome.

According to embodiments, a multi-processor may be configured to be extended based on a function and a performance

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a cross flow parallel processing system according to an embodiment of the present invention;

FIG. 2 is a diagram illustrating an example of a time-dependent database according to an embodiment of the present invention;

FIG. 3 is a diagram illustrating an example of a time-dependent database according to another embodiment of the present invention;

FIG. 4 is a block diagram illustrating a cross flow parallel processing system performing a deep packet inspection (DPI) according to an embodiment of the present invention;

FIG. 5 is a diagram illustrating an example of an L2-7 database according to an embodiment of the present invention;

FIG. 6 is a flowchart illustrating a cross flow parallel processing method according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

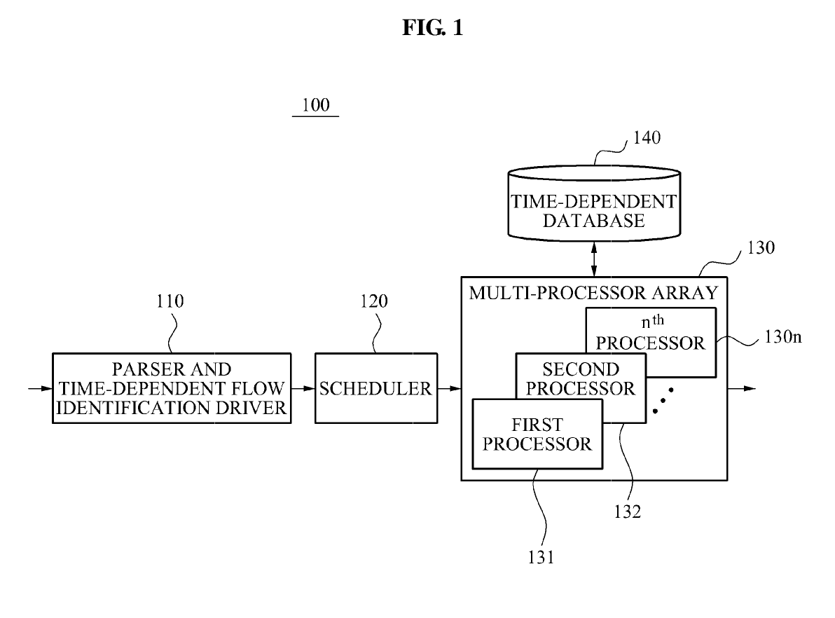

FIG. 1 illustrates a cross flow parallel processing system 100 according to an embodiment of the present invention.

Referring to FIG. 1, the cross flow parallel processing system 100 may include a time-dependent flow identification driver 110, a scheduler 120, a multi-processor array 130, a first processor 131 through an n^{th} processor 130n, and a time-dependent database 140.

The parser and time-dependent flow identification driver 110 may generate a hash key with respect to inputted data based on classification standards and data information included in the data, and may generate a has value based on the generated hash key. When the data information is Internet protocol data, the data information may include header information or payload information. The classification standards may be standards to increase a parallel processing rate. The hash value may be a flow identification.

The parser and time-dependent flow identification driver 110 may generate a data flow including the generated hash value, and may assign a sequence number to the generated data. The parser and time-dependent flow identification driver 110 may manage a state of a generated data flow and may generate a sequence number to sequentially and temporally distinguish between data flows having the same hash value. Therefore, data flows may be classified for each type, namely, each value, based on hash values, and may be temporally distinguished based on sequence numbers or time.

The scheduler 120 may assign, based on the generated hash value, the generated data flow to an available processor among multiple processors, for example, the first processor 131 through the n^{th} processor 130n.

For example, a number of cases where the scheduler 120 assigns a data flow to each processor of the multi-processor array 130 is three.

Case 1: when data flows having the same hash value as a hash value of a data flow being processed in the first processor 131 included in the multi-processor array 130 are consecutively inputted and a number of the data flows is smaller than x, x being a natural number greater than or equal to ‘2’, the scheduler 120 may assign the data flows having the same hash value to the first processor 131.

Case 2: when data flows having the same hash value as the hash value of the data flow being processed in the first processor 131 included in the multi-processor array 130 are consecutively inputted and the number of the data flows is greater than x, the scheduler 120 may assign x consecutive data flows among the data flows having the same hash value to the first processor 131, and remaining consecutive data flows to a second processor 132, an (x+1)^{th} data flow being assigned first to the second processor 132.

In this case, the scheduler 120 may perform ‘case 1’ when a number of data flows including the (x+1)^{th} data flow and data flows subsequent to the (x+1)^{th} data flow is smaller than x.

In this case, the scheduler 120 may perform ‘case 2’ when the number of data flows including the (x+1)^{th} data flow and data flows subsequent to the (x+1)^{th} data flow is greater than x.

Case 3: when a data flow having a different hash value from the data flow being processed in the first processor 131 included in the multi-processor array 130 is inputted, the scheduler 120 may assign the data flow having the different hash value to an available processor among the multiple processors 132 to 130n.

While the scheduler 120 assigns a data flow to each processor of the multi-processor array 130, performing of the case 1, the case 2, and the case 3 may be mixed. In this example, an integrity of a sequence of data flows may be lost. Therefore, to maintain the sequence of the data flows, the parse and time-dependent flow identification driver 110 may use a sequence number or a time based on a data flow unit having the same hash value.

The parser and time-dependent flow identification driver 110 may circulate sequence numbers based on a value being sufficiently greater than x set by the scheduler 120 to assign to data flows generated by the parser and time-dependent flow identification driver 110 and thus, the parser and time-dependent flow identification driver 110 may maintain a sequence of a processing result with respect to the data flows based on the sequence numbers of the data flows.

When sequence numbers with respect to data flows generated by the parser and time-dependent flow identification driver 110 are circulated based on the value being sufficiently greater than x set by the scheduler 120, the parser and time-dependent flow identification driver 110 may easily embody the sequence of the processing result with respect to the data flow. However, hardware costs may be high.

When data flows having the same hash values are consecutively inputted and the scheduler 120 sets x to be relatively small, the scheduler 120 may assign the data flows having the same hash value to a relatively greater number of processors. When the scheduler 120 sets x to be relatively small, a number of parallel-processing processors may increase and a number of processors that determine sequence numbers to maintain a sequence of the data flows may also increase.

Conversely, when the data flows having the same hash value are consecutively inputted and the scheduler 120 sets x to be relatively large, the scheduler 120 may assign the data flows having the same hash value to a relatively smaller number of processors compared with the number of the processors of when the x is set to be relatively small. When the scheduler 120 set x to be relatively large, a number of parallel-processing processors may decrease and a number of processors that determine sequence numbers to maintain a sequence of data flows may also decrease.

Therefore, the parser and time-dependent flow identification driver 110 may design a circulation size of the sequence numbers of data flows to optimize x of the scheduler 120, based on the sequence numbers with respect to the data flows generated by the parser and time-dependent flow identification driver 110 and based on maximal processing time of the consecutive data flows processed by the first processors 131 through the n^{th} processor 130n of the multi-processor array 130. The size may indicate a number of sequence numbers including sequence number ‘1’.

The first processor 131 through the n^{th} processor 130n included in the multi-processor array 130 may process data flows assigned by the scheduler 120. Also, the multi-processor array 130 may access the time-dependent database 140 when the multi-processor array 130 desires.

To sequentially and temporally distinguish between the data flows having the same hash value in the multi-processor array 130 and the time-dependent database 140, the parse and time-dependent flow identification driver 110 may include the time-dependent database 140 that assigns a sequence number having an address with respect to a number of a hash values.

When a relatively large number of hash values with respect to the data flows exist or in a special application case, the parser and time-dependent flow identification driver 110 may assign sequence numbers to a limited number of data flows, as oppose to assigning to all the hash values of the data flows The parser and time-dependent flow identification driver 110 may sequentially generate j data flows having hash values, and may assign sequence numbers to data flows having the same hash value among the j data flows. In this example, ‘j’ may be a natural number greater than or equal to ‘x’.

Hereinafter, an example where the parser and time-dependent flow identification driver 110 assigns sequence numbers to the limited number of data flows will be described.

The number of limited data flows may be assumed to be ‘j’, and ‘x’ may be x used by the scheduler 120.

The parser and time-dependent flow identification driver 110 may generate j data flows based on a sequence of generating the data flows. In this case, a j^{th} data flow may be a currently generated data flow and a first data flow is a data flow generated j−1 data flows prior to the generation of the current data flow.

When the j^{th} data flow is generated, the parser and time-dependent flow identification driver 110 may assign sequence numbers with respect to data flows that are limited to the first data flow through the j^{th} data flow, based on a data flow unit having the same hash.

When a (j+1)^{th} data flow is generated, the parser and time-dependent flow identification driver 110 may generate data flows limited to the second data flow through the (j+1)^{th} data flow, namely, may eliminate the first data flow and may add (j+1)^{th} data flow, and may assign sequence numbers with respect to the data flows, for data flows (for each data flow unit?) having the same hash value.

Sequence numbers assigned to the data flows having the same hash value among consecutive j data flows may start from ‘1’. When the data flows having the same hash value among the consecutive j data flows are generated k, k being a natural number less than or equal to j, the parser and time-dependent flow identification driver 110 may sequentially assign sequence numbers, namely, 1, . . . , k, with respect to the data flows having the same hash values.

For example, when a number of the data flows having the same hash value is k in the consecutive j data flows, the parser and time-dependent flow identification driver 110 may sequentially assign sequence numbers, namely, 1, 2, . . . , k, to the data flows having the same hash value. Conversely, when the consecutive j data flows do not include the data flows having the same hash value, the parser and time-dependent flow identification driver 110 may assign a sequence number ‘1’ to each of the data flows, namely, the parser and time-dependent flow identification driver 110 may generate j data flows having different hash values.

When the number of data flows having the same hash value among consecutive j data flows having hash values is greater than or equal to ‘p’, the parser and time-dependent flow identification driver 110 may circularly assign sequence numbers to data flows after a p^{th} data flow. In this case, to distinguish between (1) a case where a data flow circularly has a sequence number ‘1’ after assigning p sequence numbers and (2) a case where a data flow has the sequence number ‘1’ since the j consecutive data flows do not include the data flows having the same hash values or a data flow has the sequence number ‘1’ after assigning j sequence numbers, the parser and time-dependent flow identification driver 110 may add, to one of the two cases, a flag different from ‘1’ or a lower bit. For example, the parser and time-dependent flow identification driver 110 may assign a circulated sequence number to an eleventh data flow or may assign a sequence number first to a tenth data flow.

‘j’ and ‘p’ may be determined based on a configuration of the time-dependent database 140 for each application.

When the parser and time-dependent flow identification driver 110 that assigns the sequence numbers to the limited number of data flows is configured, a number of memories of the parser and time-dependent flow identification driver 110 may decrease. However, the sequence numbers are assigned not based on a type of data flow or a unit of data flows having the hash value and thus, this may be disadvantageous in an application where cross data flows are processed.

Hereinafter, the time-dependent database 140 of the present invention will be described.

When each processor included in the multi-processor array 130 processes a data flow, each processor may access the time-dependent database 140.

Therefore, the time-dependent database 140 may be distinguished with respect to the multi-processor array 130, based on each data flows and a sequence of data flows.

To determine the type of data flow and the sequence of the data flows in the time-dependent database 140 and the multi-processor array 130, a concept of ‘flow’ determined based on a time may be needed

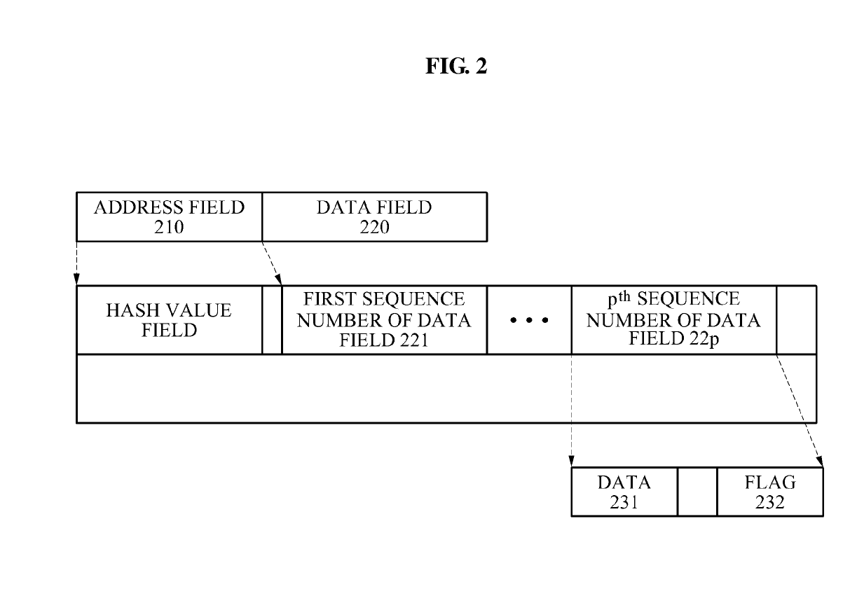

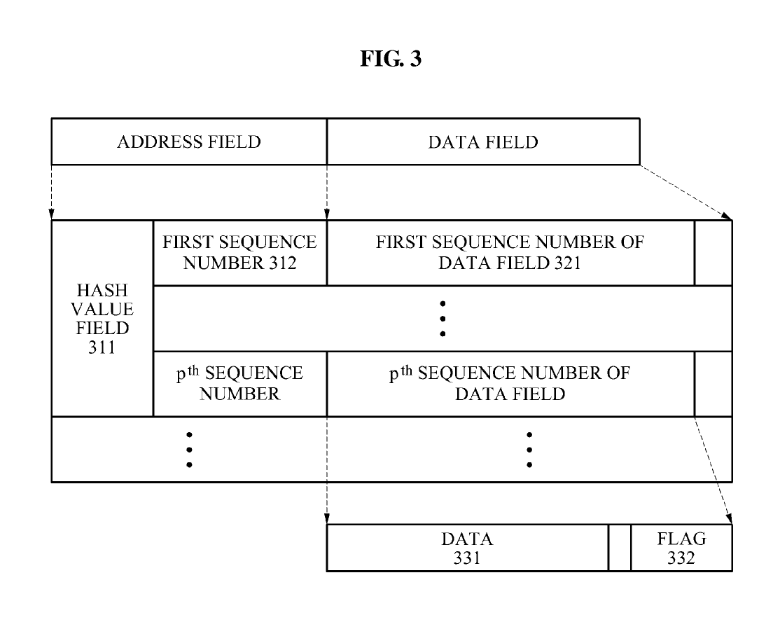

A memory table of the time-dependent database 140 may be constructed, as illustrated in FIG. 2 and FIG. 3, based on sequence numbers assigned to the data flows having the same value as a hash value generated by the parser and time-dependent flow identification driver 110.

FIG. 2 illustrates an example of a time-dependent database according to an embodiment of the present invention.

Referring to FIG. 2, for ease of description of a configuration and an operation of the time-dependent database 140, it is assumed that the time-dependent database 140 is configured by a random access memory (RAM) that is directly accessible.

The time-dependent database 140 may be a memory table including of an address and data. The memory table may include an address field 210 of a memory based on a hash value generated by the parser and time-dependent flow identification deriver 110, and may include data 231 and 232 of the memory as a data field 220 classified based on a sequence number.

As described above, when the address filed 210 of the time-dependent database 140 is composed of the hash value and the data field 220 of the time-dependent database 140 is composed of the sequence number, a task of collecting and analyzing multiple cross flows may need to be performed to obtain a result.

For ease of description, it is assumed that the parser and time-dependent flow identification driver 110 circularly generates p sequence numbers, and p is a natural number. A sequence number is assigned with respect to a hash value based on a sequence of input, namely, based on a time of input and thus, a data flow having a sequence number ‘2’ may be inputted ahead of a data flow including a hash value having a sequence number ‘3’

With respect to the hash value, the data of the time-dependent database 140 may include a data field 221 having a sequence number ‘1’ through a data field 22p having a sequence number ‘p’.

For ease of description, FIG. 2 sets a temporal classification with respect to a time-dependent hierarchical data flow as the sequence of data flows. The time-dependent database 140 may sequentially perform buffering of contents of the time-dependent database 140 to enable the multi-processor array 130 to access the time-dependent database 140 whenever the access is desired.

p virtual buffers may be given for each hash value and thus, p data fields 221 through 22p may be allocated to the single hash value. Therefore, data flows having the same hash values among data flows outputted to the parser and time-dependent flow identification driver 110 may sequentially have one of sequence numbers ‘1’ through ‘p’.

The data fields 221 through 22p of the time-dependent database 140 may be predetermined based on a policy or may be determined during an operation to be updated. A flag 232 may indicate the update when the multi-processor array 130 writes an operated result in a corresponding field of the time-dependent data base 140. When the multi-processor array 130 reads the corresponding data field and finishes, the flag 232 may be changed into an incomplete update state.

Another method to determine whether the corresponding data filed of the time-dependent database 140 is updated as follows: when an upper bit of sequence numbers assigned by the parser and time-dependent flow identification driver 110 is used as the flag 232 and the upper bit is not counted for a number of data fields of the time-dependent database 140, a synchronization between the multi-processor array 130 and the time-dependent database 140 may be determined by comparing the flag 232 with the bit among sequence numbers of the data flows.

In addition, although a flag to indicate whether a data field included in the time-dependent database 140 is to be updated is needed, this is not described due to a relatively rare occurrence.

p data fields with respect to the data flows having the same hash value may be included and thus, p processors or p threads may perform parallel-processing with respect to the data flows having the same hash value. Therefore, when a number of types of data flows is smaller than the number of processors or when same type of data flows are consecutively inputted, the data flows having the same sequence number may be assigned to multiple processor to process the data flows.

FIG. 3 illustrates an example of a time-dependent database 140 according to another embodiment of the present invention.

Referring to FIG. 3, the time-dependent database 140 may include an address field of a memory based on a hash value 311 generated by the parser and time-dependent flow identification deriver 110 and based on a sequence number generated for each data flow and may include data of the memory based on a data field. A data field 321 may include data 331 and a flag 332.

In FIG. 3, unlike FIG. 2, a sequence number is included in an address field of the memory of the time-dependent database 140 and thus, p virtual buffers may be given for a single data hierarchical flow, namely, a single hash value. Similar to FIG. 2, temporally classified multiple databases may be provided with respect to data flows having the same hash value and thus, the multi-processor array 130 may concurrently access database of a passed data flow.

When the parser and time-dependent flow identification driver 110 may assign sequence numbers to a limited number of data flows as opposed to assigning to all type of data flows, the parser and time-dependent flow identification driver 110 includes the sequence number in the address field of the memory of the time-dependent database 140 and thus, the sequence number are constructed for a single data flow being less than p. For example, when a number of sequence numbers, set by the scheduler 120, with respect to the data flows generated by the parser and time-dependent flow identification driver 110 is x, remaining a number of sequence numbers, namely, (p−x) may be included in a separate memory and thus a size of the memory of the time-dependent database 140 may be decreased. In this case, the separate memory may be a different type from the memory of the time-dependent database 140 or an address system and a data system of the memory of the time-dependent database 140 may be constructed differently from the memory of the time-dependent database 140.

Hereinafter, an embodiment where a deep packet inspection (DPI) is applied to a cross flow parallel processing system may be described.

The DPI may perform: (1) DPI with respect to a packet based on a packet unit to capture or to perform filtering of several packets, (2) DPI with respect to multiple cross packets to capture or to perform filtering of several packets, and (3) DPI with respect to packets to perform filtering a packet having an error or to switch the packet having the error to a port.

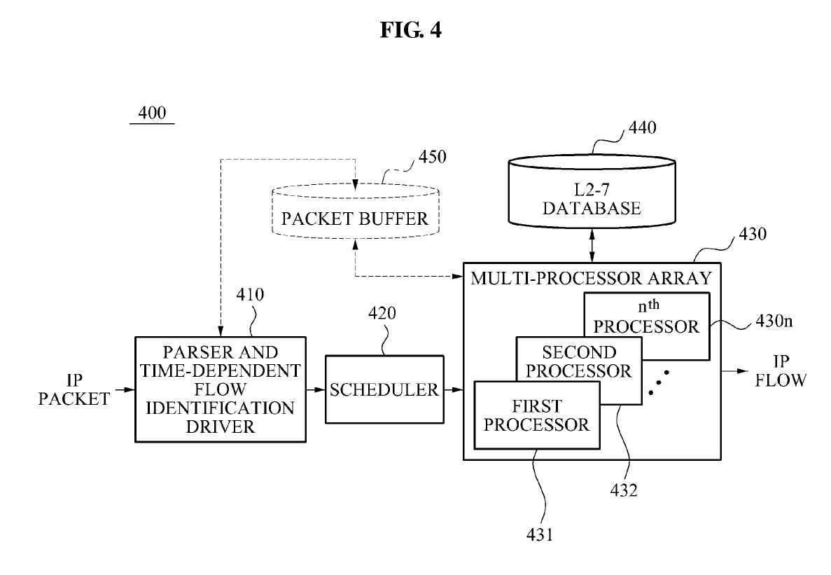

FIG. 4 illustrates a cross flow parallel processing system performing a DPI according to an embodiment of the present invention.

Referring to FIG. 4, the cross flow parallel processing system 400 performing DPI may include a parse and time-dependent flow identification driver 410, a scheduler 420, a multi-processor array 430, an L2-7 database 440, and a packet buffer 450. The multi-processor array 430 may include n processors, namely, a first processor 431 through n^{th} processor 430n, n being a natural number greater than or equal to 2.

The parser and time-dependent flow identification driver 410 may generate a hash key of a lower layer, with respect to an Internet Protocol (IP), based on information associated with a layer 2 through a layer 7 and classification rules, and may generate a hash value based on the hash key. The parser and time-dependent flow identification driver 410 may classify an IP packet based on the generated hash value, and may generate an IP flow by managing a state. A sequence of IP flows may be determined for each hash value. An attribute of a lower layer flow is determined based on a hash value, and the lower layer flow may be temporally distinguished based on a sequence number assigned thereto or a time.

The parser and time-dependent flow identification driver 410 may generate the hash value based on all or part of the information associated with the layer 2 through 7 layer, for example, information associate with a source address, a destination address, a port number, and the like, and the information used for the hash value may be header information of the IP packet.

The parser and time-dependent flow identification driver 410 may sequentially and circularly assign a sequence number ‘1’ through a sequence number ‘p’ to IP flows, p being a natural number greater than x, and thus, a processor processing result and a sequence of output of the IP flows may be maintained with respect to consecutive IP flows having the same hash value.

Although it is not illustrated in FIG. 1, a packet buffer 450 may be used to effectively use an inputted IP packet commonly in multi-processors 431 through 430n. The inputted IP packet may be stored in a packet buffer 450 to correspond to a temporally distinguished IP flow that is generated from the time-dependent flow identification deriver 410. When the packet buffer 450 is used, the multi-processor array 430 may access a content of an IP flow and thus, using of the packet buffer 450 may be a widely used technology.

The scheduler 420 may assign the IP flows generated by the parser and time-dependent flow identification driver 410 to a first processor 431 through n^{th} processor 430n of the multi-processor array 430.

There are three cases where the scheduler 420 assigns an IP flow to each of the multi-processor array 430.

Case 1: when IP flows having the same hash value as an IP flow being processed in the first processor 431 included in the multi-processor array 430 are consecutively inputted to the scheduler 420, and a number of the IP flows is smaller than x, x being a natural number greater than or equal to 2 and less than p, the scheduler 420 may sequentially assign the consecutive IP flows having the same hash value to the first processor 431 that is processing the IP flow having the same flow.

Case 2: when the IP flows having the same hash value as the IP flow being processed in the first processor 431 included in the multi-processor array 430 are consecutively inputted, and the number of the IP flows is greater than or equal to x and less than or equal to 2x, the scheduler 420 may sequentially assign x IP flows among the consecutive IP flows having the same hash value to the first processor 431 that is processing the IP flow having the same hash value. Also, the scheduler 420 may sequentially assign, to an available processor, for example the processor 432 through the processor 430n, remaining consecutive IP flows, a number of the remaining consecutive IP flows being less than or equal to x and a first assigned IP flow being a (x+1)^{th} IP flow. When the number of IP flows having the same hash value is greater than 2x, IP flows may be assigned, based on an x IP flows unit, sequentially to an available processor, for example the processor 432 through the processor 430n.

Case 3: when an IP flow having a hash value different from an IP flow being processed in the first processor 431 included in the multi-processor array 430, the IP flow having the different hash value may be assigned to an available processor, for example, the processor 432 through the processor 430n.

The multi-processor array 430 may process a lower layer flow assigned by the scheduler 420. The processor 432 through the processor 430n of the multi-processor array 430 may access the packet buffer 450 to use a packet header and payload of an IP flow to be processed.

A processing of a DPI based on a packet service attribute in the multi-processor array 430 may be performed by accessing an L2-7 database 440.

The L2-7 database 440 may be configured in two different ways respectively illustrated in FIG. 2 and FIG. 3. According to an embodiment, it is assumed that the L2-7 database 440 is configured as FIG. 2.

When the multi-processor array 430 accesses the L2-7 database 440, the multi-processor array 430 may mainly use a hash value as an address.

The multi-processor array 430 may access the L2-7 database 440 to determine a pattern or a signature, and may store a result of the determination in the L2-7 database 440 in real time, to analyze a service attribute, a transport scheme, a protocol, and the like of an IP flow.

When the consecutive IP flows having the same hash value are operated by the multi-processor array 430, the consecutive IP flows may be one-to-one matched to data of the L2-7 database 440 and thus, a synchronization of the L2-7 database 440 may be performed based on sequence numbers assigned by the parser and time-dependent flow identification driver 410.

Synchronization between the multi-processor array 430 and the L2-7 database 440 may be described.

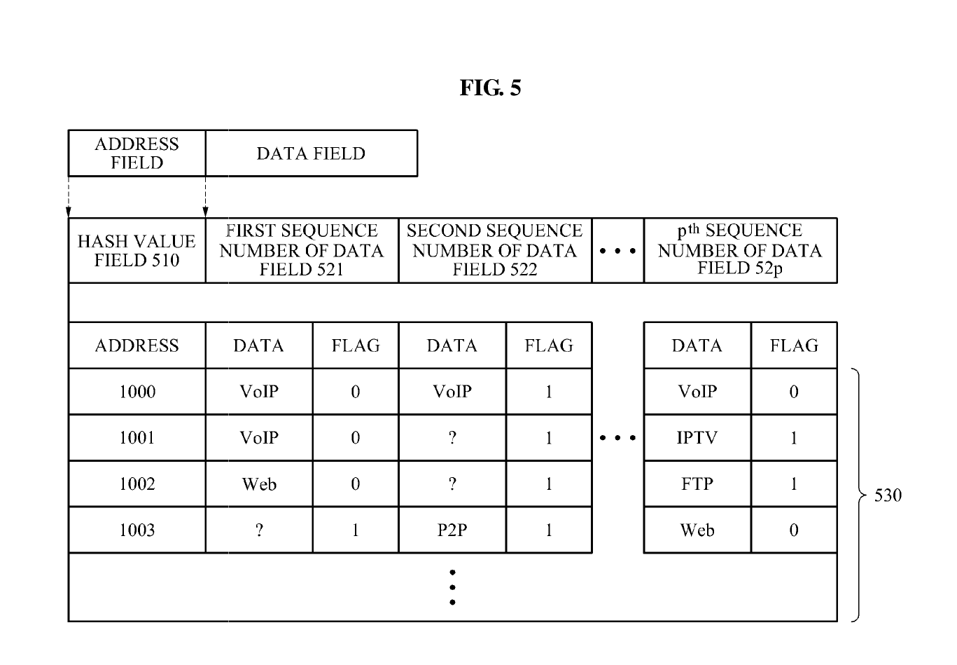

FIG. 5 illustrates an example of an L2-7 database according to an embodiment of the present invention.

Referring to FIG. 5, a data field 521 of a sequence number ‘1’ through a data field 52p of a sequence number ‘p’ may be sequence numbers ‘1’ through ‘p’ assigned by the parser and time-dependent flow identification driver 410 with respect to IP flows.

Hash values may not be one-to-one matched to consecutive multiple IP flows or multiple cross IP flows. Mostly, the IP flows may be distinguished based on a hash value. Therefore, the hash values and sequence numbers assigned with respect to IP flows having the same hash value may be needed to process multiple cross IP flows having the same hash value or to process consecutive IP flows having the same hash value. The multi-processor array 430 may use the sequence numbers assigned by the parser and time-dependent flow identification driver 410 to use a previously operated result.

For example, when a flag of the L2-7 database 440 is ‘0’, this indicates a termination of ‘read’ and thus, it is assumed that L2-7 database 440 needs to be updated. When the flag is ‘1’, it is assumed that the operation is performed in the multi-processor array 430 and the update is completed.

Referring to FIG. 5, a data field 521 through a data field 52p having a hash value of ‘1000’, namely, an address of ‘1000’ will be described. The data field 521 of the sequence number ‘1’ is ‘VoIP’ and has a flag of ‘0’. The data field 522 of the sequence number ‘2’ of data having the hash value of ‘1000’ is ‘VoIP’ and has a flag of ‘1’. It is assumed that data fields of sequence numbers ‘3’ through ‘p’ of data having the hash value of ‘1000’ are ‘VoIP’ and have a flag of ‘0’. Therefore, in this case, the data field 522 of the sequence number ‘2’ having a hash value of ‘1000’ may be effective.

Data fields having a hash value of ‘1001’, namely, an address of ‘1001’, will be described. The data field 521 of the sequence number ‘1’ is ‘VoIP’ and has a flag of ‘0’. The data field 522 of the sequence number ‘2’ of data having the hash value of ‘1001’ is ‘?’ and has a flag of ‘1’. Here, ‘?’ may denote that an operation result is not yet outputted since a cross flow operation is needed, although the multi-processor array 430 operates with respect to a corresponding IP flow. It is assumed that data fields of sequence numbers ‘3’ through ‘p−1’ of data having the hash value of ‘1001’ are ‘?’ and have a flag of ‘1’. The data field 52p of the sequence number ‘p’ of data having the hash value of ‘1001’ is ‘IPTV’ and has a flag of ‘1’. Therefore, IP flows that have the hash value of ‘1001’ and have the sequence numbers ‘2’through ‘p’ may be ‘IPTV’ traffic and may indicate that a result is obtained by performing p−1 cross flow operations.

Data fields having a hash value of ‘1002’, namely, an address of ‘1002’, of the data base 440 will be described. The data field 521 of a sequence number ‘1’ is ‘Web’ and has a flag of ‘0’. The data filed 522 of a sequence number ‘2’ of data having the hash value of ‘1002’ is ‘?’ and has a flag of ‘1’. Here, ‘?’ may denote that an operation result is not yet outputted since a cross flow operation is needed, although the multi-processor array 430 operates with respect to a corresponding IP flow. It is assumed that a data field of one of sequence numbers ‘3’ through ‘p−1’ of data having the hash value of ‘1002’ is ‘?’ and has a flag of ‘1’. The data field 52p of the sequence number ‘p’ of data having the hash value of ‘1002’ is ‘FTP’ and has a flag of ‘1’. Therefore, an IP flow that is the IP flow of the hash value of ‘1002’ and has one of the sequence number ‘2’ through ‘p’ may be ‘FTP’ traffic and may indicate that a result is obtained by performing p−1 cross flow operations.

Data fields having a hash value of ‘1003’, namely, an address of ‘1003’, of the data base 440 will be described. The data field 521 of a sequence number ‘1’ is ‘?’ and has a flag of ‘1’. Here, ‘?’ may denote that an operation result is not yet outputted since a cross flow operation is needed, although the multi-processor array 430 operates with respect to a corresponding IP flow. The data filed 522 of a sequence number ‘2’ of data having the hash value of ‘1003’ is ‘P2P’ and has a flag of ‘1’. It is assumed that data fields of sequence numbers ‘3’ through ‘p’ of data having the hash value of ‘1003’ are ‘Web’ and have a flag of ‘0’. Therefore, IP flows that have the hash value of ‘1003’ and have the sequence numbers ‘1’ through ‘2’ may be ‘P2P’ traffic and may indicate that a result is obtained by performing 2 cross flow operations.

A case where IP flows having the same hash value as an IP flow being processed in the multi-processor array 430 are consecutively inputted, and a number of the IP flows is greater than x, while the scheduler 420 assigns an IP flow to each processor included in the multi-processor array 430.

It is assumed that ‘x+r’ IP flows are consecutive inputted, first to the data field 522 of the sequence number 2 having the hash value of ‘1001’. ‘x’ and ‘r’ are natural number greater than or equal to 2, ‘x+r’ is less than ‘p’, and ‘r’ is less than ‘x’.

The data field 521 of the sequence number ‘1’ of a hash value of 1001 is ‘VoIP’ and has a flag of ‘0’. The data field 522 of the sequence number ‘2’ of data having the hash value of ‘1001’ is ‘?’ and has a flag of ‘1’. Here, ‘?’ may denote that an operation result is not yet outputted since a cross flow operation is needed, although the multi-processor array 430 operates with respect to a corresponding IP flow. It is assumed that data fields of sequence numbers ‘3’ through ‘x+r’ of data having the hash value of ‘1001’ are ‘?’ and have a flag of ‘1’. It is assumed that data fields of sequence numbers of ‘x+r+1’ through ‘p−1’ of data having the hash value of ‘1001’ are ‘?’ and have a flag of ‘1’. The data field 52p of the sequence number ‘p’ of data having the hash value of ‘1001’ is ‘IPTV’ and has a flag of ‘1’.

In this case, IP flows of sequence numbers ‘2’ through ‘x+1’, the IP flows having the hash value of ‘1001’, may be assigned to a single processor included in the multi-processor array 430. IP flows of sequence numbers ‘x+2’ through ‘x+r’ may be assigned to another single processor included in the multi-processor array 430. Therefore, a sequence of IP flows of sequence numbers ‘2’ through ‘x+1’ having a hash value of ‘1001’ and a sequence of IP flows of sequence numbers ‘x+2’ through ‘x+r’ having a hash value of ‘1001’ may be lost. However, ‘p’ is greater than ‘x’ and flags exist and thus, a re-sequence may be performed based on sequence numbers ‘1’ through ‘p’ circularly assigned, by the parse and time-dependent flow identification driver 410, to the IP flows.

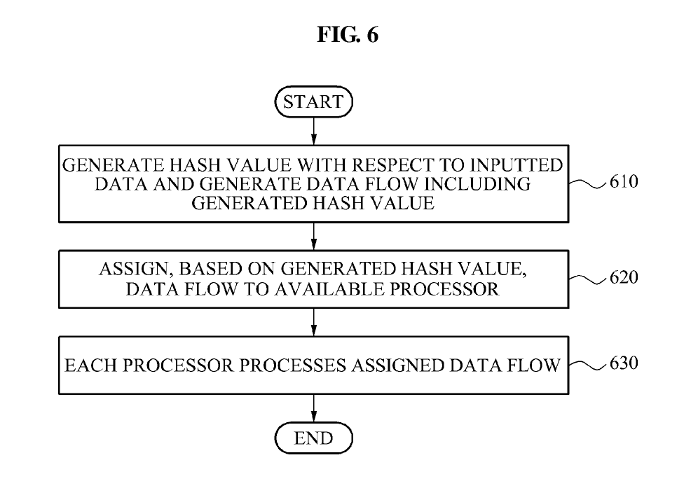

FIG. 6 illustrates a cross flow parallel processing method according to an embodiment of the present invention.

In operation 610, the cross flow parallel processing method generates a hash value with respect to inputted data. The cross flow parallel processing method may generate a hash key with respect to the inputted data based on data information and classification standards included in the data, and may generate a hash value based on the generated hash key. When the data information may be IP data, the data information may include header information or payload information. The classification standards may be standards to increase a parallel processing rate. The hash value may be a flow identification.

The cross flow parallel processing method may generate a data flow including the generated hash value, and may assign a sequence number to the generated data. The cross flow parallel processing method may manage a state of the generated data flow and may generate the sequence number to distinguish between data flows having the same hash value based on a sequence or based on a time. Therefore, data flows may be classified for each type, namely, each value, based on hash values, and may be temporally distinguished based on sequence numbers or time.

In operation 620, the cross flow parallel processing method assign, based on the generated hash value, the generated data flow to an available processor.

For example, when data flows having the same hash value as a hash value of a data flow being processed in the first processor 131 included in the multi-processor array 130 are consecutively inputted and a number of the data flows is smaller than x, x being a natural number, the cross flow parallel processing method may assign the data flows having the same hash value to the first processor 131.

When the data flows having the same hash value are consecutively inputted and the number of data flows is greater than x, x being a natural number, the cross flow parallel processing method may assign x consecutive data flows among the data flows having the same hash value to the first processor 131, and remaining consecutive data flows to a second processor 132, an (x+1)^{th} data flow being assigned first to the second processor 132.

When a data flow having a different hash value from the data flow being processed in the first processor 131 is inputted the cross flow parallel processing method may assign the data flow having the different hash value to an available processor, for example, a processor 132 through a processor 130n.

In operation 630, a processor among multiple processors process assigned data flow.

For example, the cross parallel processing method may construct a memory table including an address field and a data field, the address field being composed of the generated hash value and the data field being composed of a sequence number corresponding to the hash value.

For another example, the cross flow parallel processing method may construct a memory table including an address field and a data field, the address field being composed of the generated hash value and the sequence number and the data field being composed of processing result with respect to the data flow.

The constructed memory table may be the time-dependent database 140.

The cross flow parallel processing method may be performed by the cross flow parallel processing system of FIGS. 1 through 4. Therefore, detailed descriptions thereof will be omitted.

When the cross flow parallel processing method is performed based on the system illustrated in FIG. 4, the cross flow parallel processing method may generate a hash value with respect to an inputted IP packet, may generate an IP flow having the generated hash value, and may assign the generated IP flow to an available processor based on the hash value and thus, a processor to which the generated IP flow is assigned, from among multiple processors, may process the assigned IP flow.

The method according to the above-described embodiments of the present invention may be recorded in non-transitory computer readable media including program instructions to implement various operations embodied by a computer. The media may also include, alone or in combination with the program instructions, data files, data structures, and the like.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A cross flow parallel processing system, the system comprising:
a parser and time-dependent flow identification driver to generate a hash value with respect to inputted data and to generate a data flow including the generated hash value;
a scheduler to assign, based on the generated hash value, the generated data flow to an available processor; and
a multi-processor array to include multiple processors,
wherein each processor of the multiple processors processes data flow assigned by the scheduler.

2. The system of claim 1, wherein the parser and time-dependent flow identification driver assigns a sequence number to the data flow.

3. The system of claim 2, wherein the parser and time-dependent flow identification driver generates j data flows, and sequentially assigns sequence numbers to data flows having the same hash value among the j data flows.

4. The system of claim 1, wherein, when data flows having the same hash value as a hash value of a data flow being processed in a first processor included in the multi-processor array are consecutively inputted and a number of the data flows is smaller than x, x being a natural number, the scheduler assigns the data flows having the same hash value to the first processor.

5. The system of claim 1, wherein, when data flows having the same hash value as a hash value of a data flow being processed in a first processor included in the multi-processor array are consecutively inputted and a number of the data flows is greater than x, x being a natural number, the scheduler assigns x consecutive data flows among the data flows having the same hash value to the first processor, and remaining consecutive data flows to a second processor, an (x+1)^{th} data flow being assigned first to the second processor.

6. The system of claim 5, wherein the scheduler performs:
assigning the data flows having the same hash value to the second processor, when data flows having the same hash value as a hash value of a data flow being processed in the second processor are consecutively inputted and a number of the data flows is smaller than x; and
assigning x consecutive data flows among the data flows having the same hash value to the second processor, and remaining consecutive data flows to a third processor, an (x+1)^{th} data flow being assigned first to the third processor when the data flows having the same hash value as the hash value of the data flow being processed in the second processor are consecutively inputted and the number of the data flows is greater than x.

7. The system of claim 1, wherein, when a data flow having a different hash value from a data flow being processed in a first processor included in the multi-processor array is inputted, the scheduler assigns the data flow having the different hash value to an available processor.

8. The system of claim 1, further comprising:
a time-dependent database including a memory table including an address field and a data field, the address field being composed of the generated hash value and the data field being composed of a sequence number corresponding to the hash value.

9. The system of claim 1, further comprising:
a time-dependent database including a memory table including an address field and a data field, the address field being composed of the generated hash value and a corresponding sequence number and the data field being composed of a processing result with respect to the data flow.

10. A cross flow parallel processing system, the system comprising:
a parser and time-dependent flow identification driver to generate a hash value with respect to an inputted IP packet, and to generate an IP flow having the generated hash value;
a scheduler to assign, based on the hash value, the generated IP flow to an available processor; and
a multi-processor array to include multiple processors,
wherein each processor of the multiple processors processes the assigned IP flow.

11. A cross flow parallel processing method, the method comprising:
generating a hash value with respect to an inputted data;
generating a data flow having the generated hash value;
assigning, based on the generated hash value, the generated data flow to an available processor; and
processing the data flow in a processor to which the data flow is assigned among multiple processors.

12. The method of claim 11, wherein the generating comprises:
assigning a sequence number to the generated data flow.

13. The method of claim 11, wherein the assigning comprises:
assigning data flows having the same hash value to a first processor, when the data flows having the same hash value as a hash value of a data flow being processed in the first processor included in the multi-processor array are consecutively inputted and a number of the data flows is smaller than x, x being a natural number.

14. The method of claim 11, wherein the assigning comprises:
assigning x consecutive data flows among the data flows having the same hash value to a first processor, and remaining consecutive data flows to the second processor, an (x+1)^{th} data flow being assigned first to the second processor when the data flows having the same hash value as a hash value of a data flow being processed in the first processor included in the multi-processor array are consecutively inputted and a number of the data flows is greater than x, x being a natural number.

15. The method of claim 11, wherein the assigning comprises:
assigning data flow having a different hash value to an available processor, when the data flow having the different hash value from a data flow being processed in a first processor included in the multi-processor array.

16. The method of claim 11, further comprising:
constructing a memory table including an address field and a data field, the address field being composed of the generated hash value, and the data field being composed of a sequence number corresponding to the hash value.

17. A cross flow parallel processing method, comprising:
generating a hash value with respect to an inputted IP packet;
generating an IP flow having the generated hash value;
assigning, based on the generated hash value, the generated IP flow to an available processor; and
processing the generated IP flow in a processor to which the generated IP flow is assigned among multiple processors.
